(19) United States
(12) Patent Application Publication
(10) Pub. No.: US 2018/0373573 A1
(43) Pub. Date: Dec. 27, 2018

(54) LOCK MANAGER

(71) Applicant: HEWLETT PACKARD ENTERPRISE DEVELOPMENT LP, Houston, TX (US)

(72) Inventors: Derek Alan SHERLOCK, Boulder, CO (US); Gary GOSTIN, Plano, TX (US)

(73) Assignee: HEWLETT PACKARD ENTERPRISE DEVELOPMENT LP, Houston, TX (US)

(21) Appl. No.: 15/747,043

(22) PCT Filed: Jul. 24, 2015
(86) PCT No.: PCT/US2015/041883

§ 371 Date: Jan. 23, 2018

(51) Int. Cl. G06F 9/52

(52) U.S. Cl. CPC G06F 9/524; G06F 2209/522

(57) ABSTRACT

In some examples, a lock manager may receive a lock release message from a processor. The lock release message may identify a lock that synchronizes control of a shared resource. The lock manager may determine, for the lock identified in the lock release message, multiple processors contending to acquire the lock and select a particular processor among the multiple processors to acquire the lock.

### BACKGROUND

With rapid advances in technology, computing systems are used in virtually all aspects of society today. Computing systems and devices are increasing in complexity and processing capability, and many include complex memory systems to store immense amounts of data. Increases in the efficiency and capability of computing and memory systems will result in further widespread use and adoption of technology in nearly every facet of life.

### BRIEF DESCRIPTION OF THE DRAWINGS

Certain examples are described in the following detailed description and in reference to the drawings.

FIG. 1 shows an example of a media controller that includes a lock manager.

FIG. 2 shows an example of a system that includes lock manager to manage locks for shared resources.

FIG. 3 shows an example message sequence that processors may exchange with a lock manager.

FIG. 4 shows an example of logic that a lock manager may implement to support managing locks for shared resources of a computing system.

FIG. 5 shows another example of logic that a lock manager may implement to support managing locks for shared resources of a computing system.

FIG. 6 shows an example of logic that a media controller may implement to support processing of both lock semantic messages and memory access messages.

### DETAILED DESCRIPTION

The disclosure herein may provide for a lock manager that manages locks for shared resources of a computing system. The lock manager may select among processors contending to acquire the lock in deterministic sequence that may prevent lock starvation and reduce the impact of random factors. The lock manager may do so by eliminating polling from the lock acquisition scheme. In doing so, the lock manager may flexibly control lock acquisition according to any number of criteria, such as fairness in lock distribution, while also reducing messaging traffic as compared to polling schemes. Moreover, the features disclosed herein may support a centralized lock determination entity through the lock manager and support use of in-memory locks across a non-coherent memory fabric.

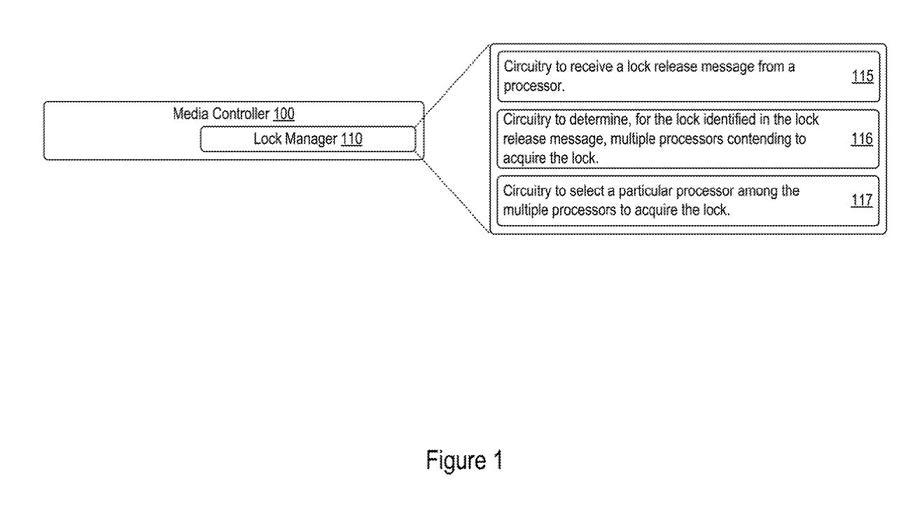

FIG. 1 shows an example of a media controller 100 that includes a lock manager 110. The media controller 100 may be any circuitry, logic, device, or system component that controls the flow of data to a memory. Thus, the media controller 100 may control read and write accesses to a memory of a computing system, whether as a separate controller chip or integrated as part of another chip (e.g., as part of a microprocessor). In some examples, the media controller 100 controls access to a particular memory or memory region for multiple processors in a computing system that share use of the particular memory or memory region.

The media controller 100 in FIG. 1 includes a lock manager 110. As described in greater detail below, the lock manager 110 may manage locks to shared resources of a computing system. A lock may apply to various types of shared resources in a computing system, examples of which include a memory location that the media controller 100 controls access to, memory locations of memories controlled by other media controllers, a peripheral, a storage device, a non-reentrant code region, and more. In some implementations, the lock manager 110 is implemented as part of the media controller 100 itself, such as through sub-circuitry of the media controller 100. However, the lock manager 116 may be implemented in various forms and in many different ways, whether as part of a media controller 100, as a separate logical or physical entity, as part of another system component, or as combinations thereof. Accordingly, the lock manager 110 may take various forms, including as dedicated circuitry (such as an application specific integrated circuit), a hardware state machine, executable instructions stored on a machine-readable medium, general purpose hardware providing lock manager features, or through various other implementation options.

In operation, the lock manager 110 may manage locks for shared system resources. A lock may serve as a synchronization mechanism to control accesses to a shared resource by multiple different system components, processes, or execution threads. The lock may also be referred to as a mutex, and multiple processors or execution threads may acquire a lock in order to access or modify the shared resource that the lock applies to, and in a mutually exclusive manner. The lock manager 110 may arbitrate between multiple processors independently and asynchronously seeking to acquire the lock, and grant the lock to the multiple processors in a deterministic order to reduce disproportionate lock acquisition rates or prevent lock starvation for the processors contending to acquire the lock.

As one particular example, the lock manager 110 shown in FIG. 1 includes the circuitry labeled as 115, 116, and 117, which may be implemented according to any form the lock manager 110 takes. Through the circuitry 115, 116, and 117, the lock manager 110 may receive a lock release message from a processor, the lock release message identifying a lock for a shared resource that synchronizes control of the shared resource; determine, for the lock identified in the lock release message, multiple processors contending to acquire the lock; and select a particular processor among the multiple processors to acquire the lock.

By deterministically selecting a processor to acquire a lock, the lock manager 110 may prevent lock starvation that may occur when lock acquisition is determined randomly. For instance, in polling-based lock acquisition schemes, whether a particular processor acquires a lock or not may depend on the moment in time when the processor's lock request (e.g., swap operation) reaches a media controller. In these polling-based lock acquisition schemes, a particular processor may successively acquire the lock multiple times before other contending processors acquire the lock one time. Thus, polling based lock acquisition schemes may result in a particular processor or thread acquiring the lock a disproportionate amount of times as compared to other contending processors, which may be referred to as unfairness in the distribution of the lock amongst contending processors. In the extreme case, one processor may never succeed in obtaining the lock, in which case starvation has occurred.

In contrast, the lock manager 110 may selectively determine an acquisition order for the lock, thereby allowing the lock manager 110 to reduce or prevent such unfairness and eliminate lock starvation. In that regard, the lock manager 110 may reduce or eliminate the impact of factors that affect polling based schemes, such as the randomness and luck in timing of lock requests or the physical distance of a processor from a media controller, which may impact the processor's ability to aggressively poll a lock due to a longer message transmission latency. The lock manager 110 may also provide lock control and management with reduced messaging traffic as compared to polling-based schemes, which may increase the efficiency of memory fabrics and reduce system power usage.

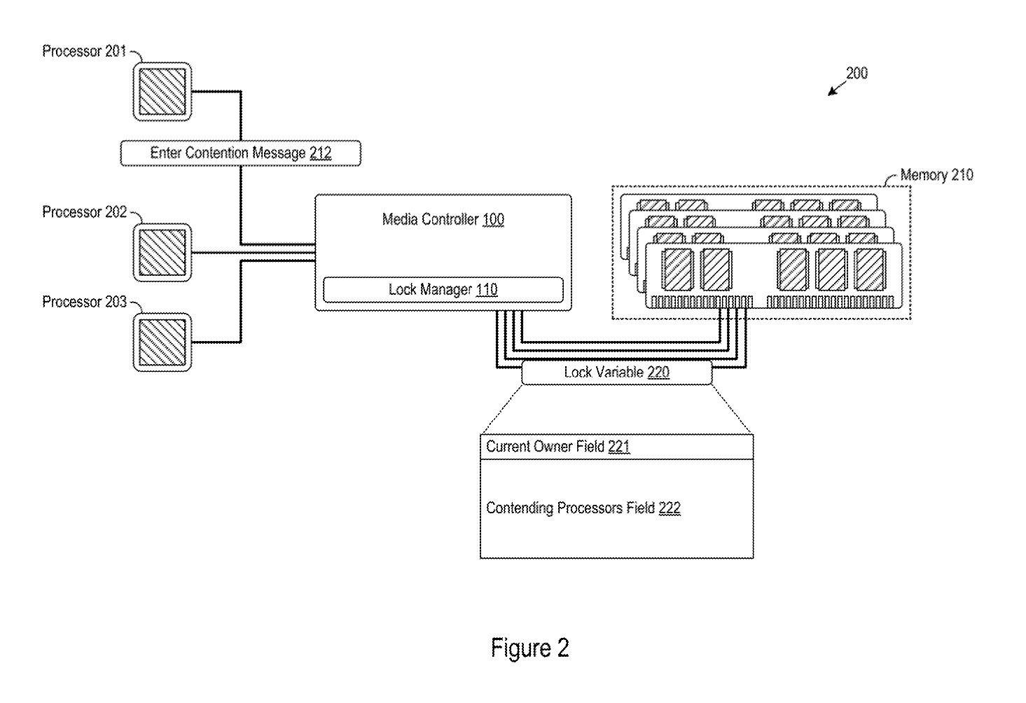

Some example features of the lock manager 110 are described in greater detail next. FIG. 2 shows an example of a system 200 that includes a lock manager 110 to manage locks for shared resources. The system 200 includes multiple processors, including the processors labeled as 201, 202, and 203, as well as a media controller 100 and a memory 210. The processors 201, 202, and 203 may be separate central processing units (CPUs) of a multi-processor computing system, and may execute separate threads that access a shared resource, such as the memory 210.

The memory 210 may be any memory or memory portion of a computing system. As examples, the memory 210 may be a dynamic random access memory (DRAM) or a non-volatile memory such as a memristor array, Electrically-Erasable Programmable Read-Only Memory (EEPROM), a storage drive, an optical disk, and the like. The memory 210 may be non-cache-coherent with respect to other memories of the computing system, such as local caches of the processors 201, 202, and 203 or other memory portions of a computing system (e.g., other controller-memory pairs for other portions of a system memory). In that regard, the lock manager 110 may provide deterministic and centralized lock acquisition techniques for a computing system, including systems with non-coherent memories and a non-coherent memory fabric. That is, instead of using CPU based locking primitives dependent upon cache-coherent behavior, the lock manager 110 may support in-memory lock variables for synchronizing control of a shared resource in non-coherently shared memories.

In operation, the media controller 100 may control accesses to the memory 210 by the processors 201, 202, and 203. As the processors 201, 202, and 203 execute respective threads, the processors 201, 202, and 203 may request to acquire a lock for a particular shared resource, an example of which is a memory location of the memory 210. In that regard, the processors 201, 202, and 203 may contend with one another to acquire the lock, e.g., for a particular memory location to modify data stored at the particular memory location. The lock manager 110 may arbitrate between the processors 201, 202, and 203 to determine which of the processors to grant the lock for the shared resource to.

In acquiring and releasing locks for shared resources of a computing system, the lock manager 110 and the processors 201, 202, and 203 may exchange lock-semantic messages. Lock semantic messages may include any message exchanged between the lock manager 110 and a processor with regards to a lock for a shared resource. The media controller 100 may recognize lock semantic messages and pass received lock semantic messages to the lock manager 110 for processing. Examples of lock semantic messages include an enter contention message sent by a processor to request a lock, a lock win message sent by the lock manager 110 to indicate acquisition of a lock, and a lock release message sent by a processor to release a previously acquired lock.

To identify a particular lock to acquire or release, a lock semantic message may include a lock identifier field. The lock identifier field may specify any unique lock identifier value that maps to a particular lock. In some examples, the lock identifier field specifies a memory address corresponding to a particular lock, such as a lock address in a memory storing the lock state of the particular lock. Portions of a memory allocated to store lock state (e.g., via lock variables) may be referred to as a lock variable storage location. In other examples, the lock identifier field may specify any other unique lock identifier value, which the lock manager 110 may map to a particular lock address to retrieve the lock state from.

Returning to the example shown in FIG. 2, the processor 201 sends an enter contention message 212 to the lock manager 110. The enter contention message 212 may specify a particular lock that the processor 201 requests to acquire, for example as identified through a particular lock address storing lock state information for the lock or through other lock identifier values.

A processor may generate and send an enter contention message 212 to the lock manager 110 in various ways. In some examples, the enter contention message 212 (and other lock semantic messages such as the lock release message) may be generated and sent as a result of executing an instruction of an instruction set architecture (ISA) supported by the processor. In other examples, a processor may include dedicated lock semantic circuitry or logic to generate the enter contention message 212, such as in response to a sideband control mechanism of a thread executed by the processor. The sideband control mechanism may include setting a particular control register value and, in response, the dedicated circuitry may generate and send the enter contention message 212 to the lock manager 110. The processor may generate other lock semantic messages in a similar way.

In response to receiving the enter contention message 212, the lock manager 110 may determine whether to grant the lock to the processor 201 or not. To do so, the lock manager 110 may determine a current state of the requested lock by accessing a lock variable for the requested lock, shown in FIG. 2 as the lock variable 220. The lock variable 220 may indicate a state of a lock for a shared resource, including whether or not the lock is acquired and if so, by which processor as well as any other processors contending to acquire the lock. The lock manager 110 may retrieve the lock variable 220 from a lock variable storage location of the memory 210. In that regard, the lock manager 110 itself may not store or track lock state, instead utilizing the memory 210 to store lock state.

In the example shown in FIG. 2, the lock variable 220 includes a current owner field 221 and a contending processors field 222. The current owner field 221 may identify a particular processor that has currently acquired the lock, and may specify an unowned value when the lock is open (e.g., not acquired). The contending processors field 222 may indicate any processors contending to acquire the lock, which may include any processors from which an enter contention message 212 was previously received for the lock and are currently awaiting to acquire the lock. As such, the contending processors field 222 may be empty when the lock is open or when no other processors besides the present lock owner are contending for the lock. The contending processors field 222 may also include any scoring data, weight data, or queue position used by the lock manager 110 to determine which of the contending processors to grant a released lock to.

Continuing the illustration shown in FIG. 2, the lock manager 110 may access the lock variable 220 after receiving the enter contention message 212 from the processor 201 and examine the current owner field 221. When the requested lock is not presently acquired, the lock manager 110 may grant the lock to the processor 201. To do so, the lock manager 110 may modify the current owner field 221 of the lock variable 220 to indicate the processor 201 as having currently acquired the lock. The lock manager 110 may also send a lock win message (not shown) to the processor 201. When the current owner field 221 of the lock variable 220 indicates the lock as acquired by a different processor, the lock manager 110 may add the processor 201 to the contending processors field 222 of the lock variable 220.

Through the enter contention message 212, the processor 201 may enter contention to acquire a lock without having to poll for the lock. Such polling may require the processor 201 to send multiple locking messages while awaiting to acquire the lock. In contrast to such a polling scheme, the processor 201 may enter contention for a lock through a single lock semantic message, and await receiving of a lock win message from the lock manager 110 without having to send additional polling messages to the lock manager 110. The processor 201 may eventually acquire the lock requested via the enter contention message 212, for example by receiving a lock win message from the lock manager 110 subsequent to sending the enter contention message 212. Thus, processors of a system may contend to acquire a lock for a shared resource through the exchange of lock semantic messages with the lock manager 110.

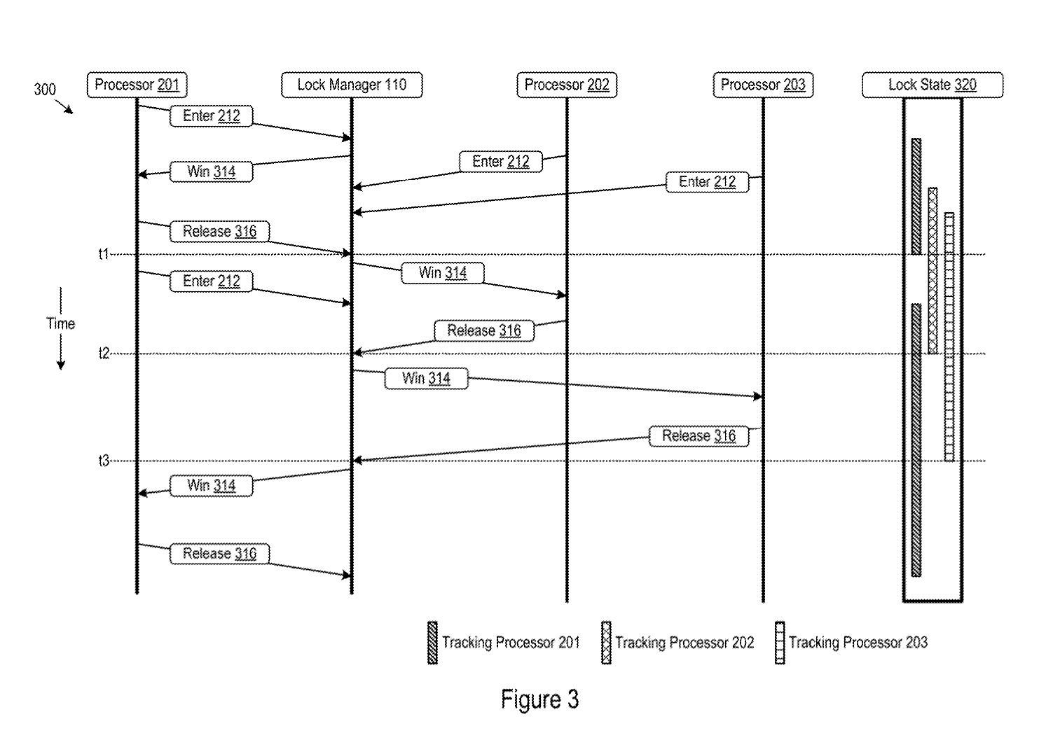

FIG. 3 shows an example message sequence 300 that processors may exchange with a lock manager 110. In particular, the example message sequence 300 shown in FIG. 3 is presented with respect to the processors 201, 202, and 203 and a lock manager 110. The example message sequence 300 depicts various lock semantic messages that processors may exchange with a lock manager 110 to acquire and release a particular lock. The lock semantic messages may include enter contention, lock win, and lock release messages exchanged between the processors 201, 202, and 203 and the lock manager 110. The lock semantic messages exchanged in FIG. 3 may apply to the same lock. The lock semantic messages may identify the same lock by, for example, specifying the same lock address storing the lock variable 220 of the lock.

The processors 201, 202, and 203 may respectively send an enter contention message 212 to the lock manager 110 to acquire the same lock. The lock manager 110 may receive the various enter contention messages 212 and select a particular processor to grant the lock to. In the example shown in FIG. 3, the lock manager 110 first receives the enter contention message 212 from the processor 201, and at a time when the lock is not acquired. Thus, the lock manager 110 responds to the processor 201 with a lock win message 314. After granting the lock to the processor 201 and prior to receiving a lock release message 316 from the processor 201, the lock manager 110 may receive enter contention messages 212 from the processor 202 and 203 respectively. In response to receiving these messages, the lock manager 110 may update the lock state to indicate the processors 202 and 203 as contending processors for the lock while the lock is acquired (or, put another way, owned) by the processor 201, e.g., by updating the lock variable 220 of the lock.

At time t1, the lock manager 110 receives a lock release message 316 from the processor 201 releasing the previously acquired lock. The lock release message 316 may be generated by the processor 201 as a result of the execution of a particular instruction of an instruction set architecture supported by the processor 201. As another example, the lock release message 316 may be generated by dedicated lock semantic generation circuitry of the processor 201. Upon receiving the lock release message 316, the lock manager 110 may determine any other contending processors for the lock, and identify the processors 202 and 203 as contending processors from which enter contention messages 212 were previously received. The lock manager 110 may select one of the contending processors to grant the lock to.

The lock manager 110 may employ any number of selection schemes to determine a contending processor to grant a lock to. The lock manager 110 may employ a selection scheme to meet any number of criteria, such as prevention of lock starvation, fairness in lock acquisition, or granting the locks to the processors 201, 202, and 203 according to a priority rate or in weighted proportions. As examples, the lock manager 110 may select a particular processor to grant the lock to through a round robin selection scheme, first-in-first-out queuing scheme, a weighted selection scheme, or according to any other deterministic selection scheme to control the order, rate, or distribution at which the lock is granted to contending processors.

The lock manager 110 may implement a scorecard or queue for contending processors, allowing the lock manager 110 to grant the lock in a sequence such that a particular processor is granted within a target grant rate over a period of time. The lock manager 110 may select a contending processor to grant the lock in a fair, starvation-free sequence, such as in the order by which enter contention messages 212 were received from the contending processors. In the example shown in FIG. 3, the lock manager 110 determines to grant the lock to the processor 202 after receiving the lock release message 316 at time t1. Then, the lock manager 110 sends a lock win message 314 to the processor 202. The lock win message 314 may take any form to indicate to the processor 202 that the processor 202 has acquired the lock for the shared resource.

At time t2, the lock manager 110 receives a lock release message 316 from the processor 202. In response, the lock manager 110 may again determine a contending processor to grant the lock to, this time among the processors 201 and 203. The lock manager 110 may grant the lock to the processor 203, and thus send a lock win message 314 to the processor 203. In doing so, the lock manager 110 may select the processor 203 instead of the processor 201 to reflect the order in which the enter contention messages 212 were received from the processors 201 and 203. After receiving a lock release message 316 from the processor 203 at time t3, the lock manager 110 may then grant the lock to the processor 201, the only processor contending to acquire the lock at that time.

FIG. 3 also shows a lock state 320, which may show the various processors tracked as having acquired or contending to acquire the lock. The lock state 320 may be implemented through the lock variable 220 of the lock, stored at a lock address in the memory 210. As shown in FIG. 3 through various shaded bars, the lock state 110 may track when the processors 201, 202, and 203 have currently acquired the lock or are contending for the lock. By tracking which of the processors 201, 202, and 203 have acquired or are contending to acquire a lock, the lock state 320 may allow the lock manager 110 to issue lock win messages 314 to contending processors after a previous owner releases the lock in a deterministic sequence. The lock manager 110 may access the lock state 320 through a read operation of the lock variable 220 at specific points in time, e.g., in response to receiving an enter contention message 212 or a lock release message 316. In contrast to polling schemes, the lock manager 110 may exhibit control over which particular processor next acquires the lock while also reducing messaging traffic that the processors 201, 202, and 203 exchange with a media controller to acquire a lock.

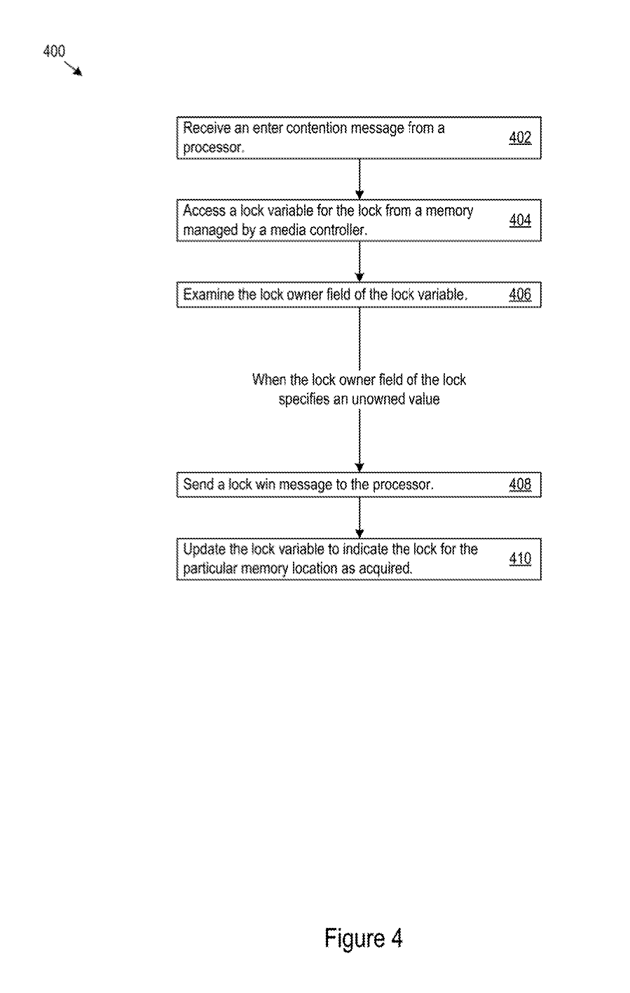

FIG. 4 shows an example of logic 400 that a lock manager 110 may implement to support managing locks for shared resources of a computing system. The lock manager 110 may implement the logic 400 as, for example, hardware, executable instructions stored on a machine-readable medium, or combinations of both, and the lock manager 110 may perform or execute the logic 400 as a method.

The lock manager 110 may receive an enter contention message 212 from a processor (402). The enter contention message 212 may request to acquire a lock for a shared resource. In some examples, the enter contention message 212 may be generated by a processor as a result of executing an instruction of an instruction set architecture supported by the processor.

In response to receiving the enter contention message 212, the lock manager 110 may access a lock variable for the lock (404). In some examples, the enter contention message 212 includes a lock address identifying the lock that the processor is requesting to acquire. The lock manager 110 may access the lock variable 220 by reading the lock variable from a lock variable storage location of a memory specified through the lock address. The lock variable accessed by the lock manager 110 may include a lock owner field 221 to indicate a particular processor that has acquired the lock or an unowned value when the lock is not acquired and a contending processor field 222 to indicate which processors are currently contending to acquire the lock for the shared resource.

Upon accessing the lock variable, the lock manager 110 may examine a lock owner field 221 of the lock variable (406). When the lock owner field 221 of the lock variable specifies an unowned value, the lock manager 110 may send a lock win message 314 to the processor (408) and update the lock variable to indicate the lock for the shared resource as acquired (410). For instance, the lock manager 110 may update the lock variable to indicate the lock as acquired by setting the lock owner field 221 to indicate the processor has acquired the lock. When the lock owner field 221 specifies the lock for the shared resource is acquired by a different processor, the lock manager 110 may update the contending processor field 222 to include the processor as a contending processor for the lock.

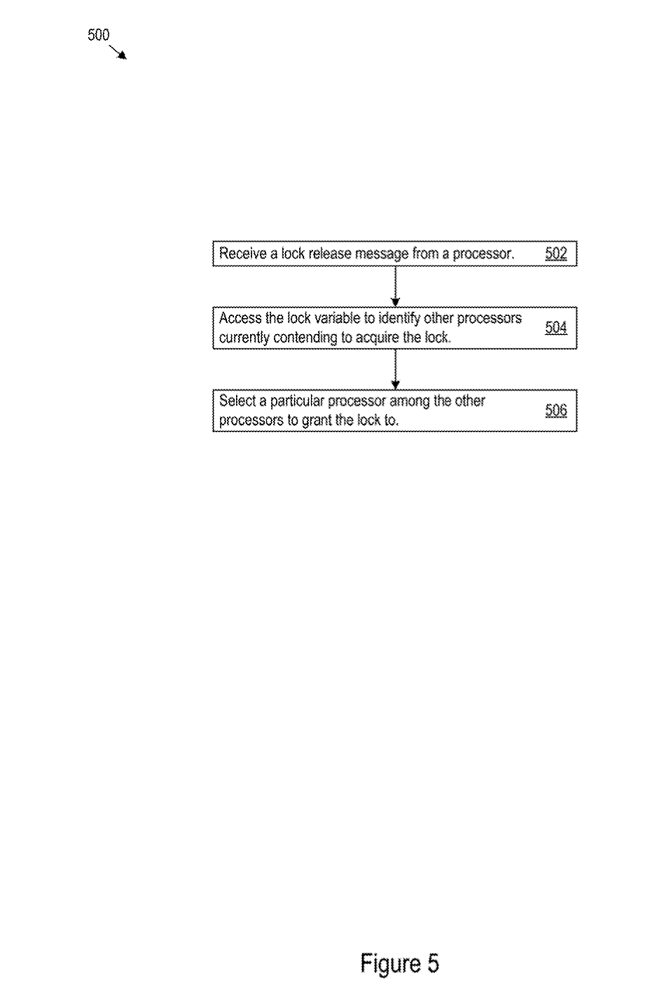

FIG. 5 shows another example of logic 500 that a lock manager 110 may implement to support managing locks for shared resources of a computing system. The lock manager 110 may implement the logic 500 as, for example, hardware, executable instructions stored on a machine-readable medium, or combinations of both, and the lock manager 110 may perform or execute the logic 500 as a method.

The lock manager 110 may receive a lock release message 316 from a processor (502). The lock release message 316 may indicate the release of a lock previously acquired by the processor for a shared resource. In response to receiving the lock release message 316, the lock manager 110 may access a lock variable to identify other processors currently contending to acquire the lock released by the processor (504). In some examples, the lock manager 110 accesses the lock variable by retrieving the lock variable from a lock variable storage location of a memory managed by the media controller. By utilizing the memory to store the lock variable, the lock manager 110 may quickly and efficiently access the lock variable and without having to allocate physical space on the memory controller to store the lock variable. Storing the lock state in memory may allow the computing system implementing the lock manager 110 to scale to an arbitrarily large number of locks concurrently in use. Thus, the system may support dynamic allocation of an additional lock by allocating another lock variable storage location in the memory.

In other examples, the lock manager 110 itself may include storage capabilities for the lock variable, such as an embedded storage location implemented by a media controller that the lock manager 110 is part of. In these examples, the lock manager 110 may access the lock variable by retrieving the lock variable from the embedded storage implemented by the media controller.

For the other processors currently contending to acquire the released lock, the lock manager 110 may select a particular processor among the other processors to grant the lock to (506). After selecting the particular processor to grant the lock to, the lock manager 110 may send a lock win message 314 to the particular processor and update a lock owner field of the lock variable to specify the particular processor has acquired the lock.

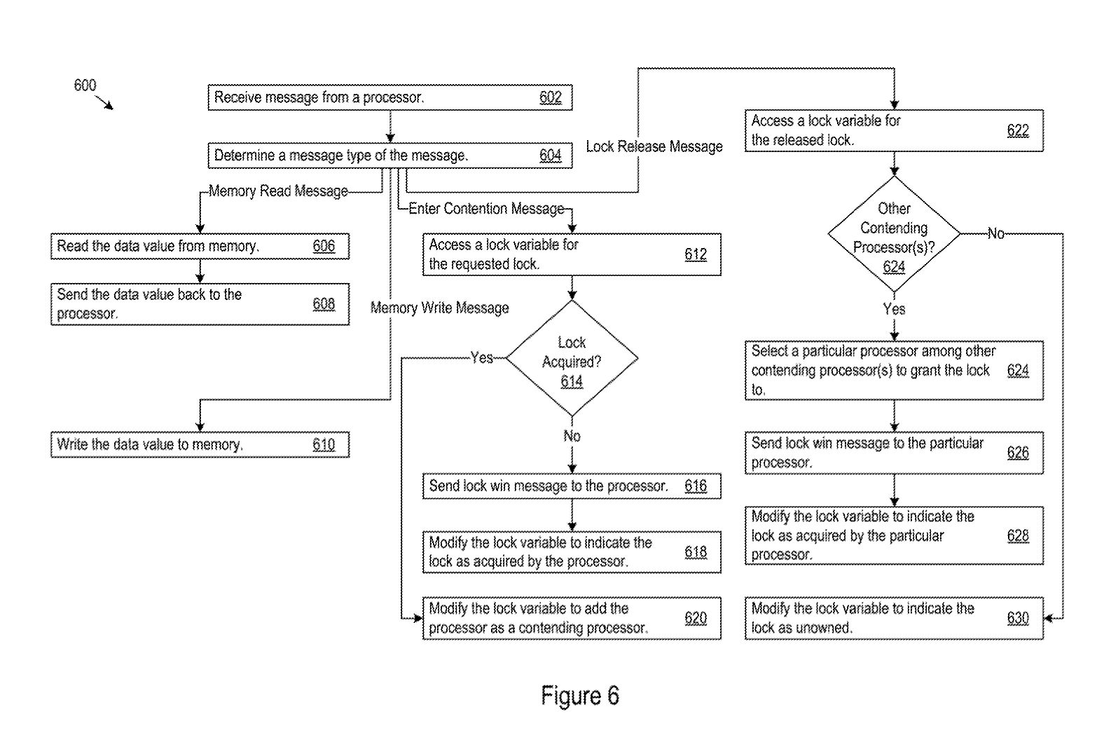

FIG. 6 shows an example of logic 600 that a media controller may implement to support processing of both lock semantic messages and memory access messages. The media controller may implement the logic 600 as, for example, hardware, executable instructions stored on a machine-readable medium, or combinations of both, and the media controller may perform or execute the logic 600 as a method. For example, some or all of the features of the logic 600 may be performed by or implemented through a lock manager 110, such as the processing of lock semantic messages.

The media controller may receive a message from processor (602) and determine a message type of the message (604). In that regard, the media controller may determine whether the message is a memory access message (e.g., a memory read or write message) or a lock semantic message (e.g., an enter contention message or a lock release message),

When the message is a memory access message, the media controller may access the memory to perform a memory read or write. For a memory read message, the media controller may read the data value requested from the memory (606) and send the data value back to the processor (608). For a memory write message, the media controller may write the data value specified in the memory write message to the memory (610).

For lock semantic messages, the media controller may process the lock semantic messages through a lock manager 110. When the message is an enter contention message 212 from the processor, the lock manager 110 may access a lock variable for the requested lock (612). In some examples, the lock manager 110 retrieves the lock variable from the lock address located within a memory managed by a media controller implementing the lock manager 110. The lock address may be a particular memory address in the memory designated as a lock variable storage location.

The lock manager 110 may examine the lock variable for the requested lock to determine whether the requested lock is acquired or not (614). For example, the lock manager 110 may examine a current owner field of the lock variable. When the lock manager 110 determines the lock is not acquired, the lock manager 110 may grant the requested lock to the processor by sending a lock win message 314 to the processor (616) and modifying the lock variable to indicate the lock as acquired by the processor (618). In doing so, the lock manager 110 may set a current owner field of the lock variable to indicate the lock variable as acquired by the processor and write the modified lock variable back into the memory. When the lock manager 110 determines the lock is acquired, the lock manager 110 may modify the lock variable to add the processor as a contending processor (620), such as by updating a contending processor field of the lock variable to add or queue the processor.

When the message received from the processor is a lock release message 316, the lock manager 110 may access the lock variable for the released lock (622). Then, the lock manager 110 may determine whether any other processors are also contending to acquire the released lock (624), such as by examining the contending processors field of the lock variable. When the lock manager 110 determines another processor (or multiple other processors) are contending to acquire the released lock, the lock manager 110 may select a particular processor among the contending processor(s) to grant the lock to (624), and in any of the ways or according to any of the criteria or goals described above. Then, the lock manager 110 may send a lock win message to the particular processor selected to acquire the lock (626) as well as modify the lock variable to indicate the particular processor as acquired by the particular processor (628). When the lock manager 110 determines no other processor is contending to acquire the released lock, the lock manager 110 may modify the lock variable to indicate the lock as unowned (630).

In some examples, the lock manager 110 may release a lock without receiving a lock release message 316 from the processor that acquired the lock. The lock manager 110 may do so when the processor holds the lock for more than a threshold amount of time. Thus, the lock manager 110 may prevent deadlock when a failed CPU or crashed software thread is holding a lock, keeping other processors and execution threads from accessing the particular memory location that the lock applies to. Upon unilaterally releasing the lock, the lock manager 110 may select a contending processor to acquire the lock as described above or set the lock as unowned when no other processors are contending to acquire the lock.

Such unilateral, timeout-driven release of an owned lock by the lock manager 110 may be useful in high-availability designs. High availability designs may refer to systems with specific system availability requirements, such as systems requiring a computing system continue to operate even after the loss, disabling, or malfunctioning of system components. As one example, business requirements may specify the computing system 200 to be high availability system and continue to operate even after the loss of a processor 201, 202, or 203, or after the failure of software running on a processor.

When unilaterally releasing a lock without receiving a lock release message from a previous owner of the lock, the lock manager 110 may send a distinct “broken lock” variant of the lock win message 314 to the contending processor selected to next acquire the lock. The “broken lock” variant of the lock win message 314 may include an indicator, flag, or value to indicate to the processor that the lock was unilaterally released by the lock manager 110. Receiving the “broken lock” variant of the lock win message 314 may cause the contending processor acquiring the lock to execute additional software code to perform a clean-up of the lock, for example before proceeding with the execution of any code by the contending processor that depends upon proper synchronization provided by the lock.

A media controller may support access to a memory, whether through memory access operations (such as a read or write) or through processing of a lock semantic message (which may result in a modified value to a lock variable stored in the memory). A computing system may allocate portions of a memory as lock variable storage locations, and may allocate other portions of the memory as non-lock variable storage locations. For example, an operating system or other control logic of the computing system may ensure that lock variable storage locations are accessed through lock semantic messages, but not through memory access messages and vice versa for non-lock variable storage locations. Thus, a memory controlled by the media controller may be intermixed with lock variable storage locations and non-lock variable storage locations.

Control logic may dynamically repurpose a particular memory location from storing a lock variable to not, or vice versa, just by the switching access operations used upon the particular memory location (e.g., switching between lock semantic and memory access operations). The media controller need not require any advanced knowledge of the access mode to be used for any given memory address, since the type of access operations received from the processors determine which type of semantics to employ.

The methods, circuitry, devices, systems, and logic described above, including the lock manager 110, may be implemented in many different ways in many different combinations of hardware, executable instructions stored on a machine-readable medium, or combinations of both. For example, all or parts of the lock manager 110 may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. The processing capability of the systems, devices, and circuitry described herein, including the lock manager 110, may be distributed among multiple system components, such as among multiple processors, controllers, memories, and logic, possibly including multiple distributed processing systems.

All or part of the circuitry, systems, devices, and logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

Some example implementations have been described. Other implementations are possible.

1. A device comprising:
a lock manager to:
receive a lock release message from a processor, the lock release message identifying a lock for a shared resource that synchronizes control of the shared resource;
determine, for the lock identified in the lock release message, multiple processors contending to acquire the lock; and
select a particular processor among the multiple processors to acquire the lock.

2. The device of claim 1, wherein the lock manager is to select the particular processor as part of a deterministic sequence to prevent a contending processor from acquiring the lock twice before another contending processor acquires the lock once.

3. The device of claim 1, wherein the lock manager is to determine the multiple processors by:
accessing a lock variable for the lock, the lock variable comprising a contending processor field to indicate which processors are currently contending to acquire the lock for the shared resource; and
examining the contending processor field to identify the multiple processors.

4. The device of claim 1, wherein the lock manager is further to, after selecting the particular processor to acquire the lock:
send a lock win message to the particular processor indicating the particular processor has acquired the lock.

5. The device of claim 4, wherein the lock manager is to identify the lock in the lock win message by specifying a lock address of the lock in the lock win message.

6. The device of claim 1, wherein the lock manager is further to:
receive an enter contention message from a processor, the enter contention message requesting to acquire the lock for the shared resource;
access a lock variable for the lock to determine a whether the lock is currently acquired;
when the lock variable indicates the is acquired:
specify, in the lock variable, the processor as a contending processor contending to acquire the lock; and
when the lock variable indicates the lock is not acquired:
grant the lock to the processor.

7. A method comprising:
through a lock manager of a media controller:
receiving an enter contention message from a processor, the enter contention message requesting to acquire a lock for a shared resource;
accessing a lock variable for the lock from a memory managed by the media controller, the lock variable comprising:
a lock owner field to indicate a particular processor that has acquired the lock or an unowned value when the lock is not acquired; and
a contending processor field to indicate which processors are currently contending to acquire the lock for the shared resource;
examining the lock owner field of the lock variable; and
when the lock owner field of the lock variable specifies the unowned value:
sending a lock win message to the processor; and
updating the lock variable to indicate the lock for the shared resource as acquired.

8. The method of claim 7, further comprising:
when the lock owner field specifies the lock for the shared resource is acquired by a different processor:
updating the contending processor field to include the processor as a contending processor for the lock.

9. The method of claim 7, wherein updating the lock variable to indicate the lock as acquired comprises setting the lock owner field to indicate the processor has acquired the lock.

10. The method of claim 7, wherein the enter contention message comprises a lock address identifying the lock; and
wherein the lock manager is to access the lock variable by reading the lock variable from the lock address.

11. A method comprising:
through a lock manager of a media controller:
receiving lock release message from a processor, the lock release message to release a lock previously acquired by the processor for a shared resource, and in response:
accessing a lock variable to identify other processors currently contending to acquire the lock for the shared resource; and
selecting a particular processor among the other processors to grant the lock to.

12. The method of claim 11, further comprising, after selecting the particular processor to grant the lock to:
sending a lock win message to the processor; and
updating a lock owner field of the lock variable to specify the processor has acquired the lock.

13. The method of claim 11, comprising selecting the particular processor through a round robin selection scheme, first-in-first-out queuing scheme, or a weighted selection scheme.

14. The method of claim 11, wherein accessing the lock variable comprises retrieving from the lock variable from a lock variable storage location of a memory managed by the media controller.

15. The method of claim 14, wherein the lock release message comprises a lock address for the lock, the lock address identifying the lock variable storage location of the memory.
